(19) United States
(12) Patent Application Publication
(10) Pub. No.: US 2005/0076562 A1
(43) Pub. Date: Apr. 14, 2005

(54) Instant topiary frame apparatus and method of manufacture

(76) Inventor: Chen Chin J. Huang, San Martin, CA (US)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/674,589

(22) Filed: Sep. 29, 2003

(51) Int. Cl. A01G 17/06

(52) U.S. Cl. 47/44

(57) ABSTRACT

An embodiment of the present invention is a maneuverable topiary frame for instant application to topiary related shrubs, trees, plants, and foliage. The embodiment allows for instant use to already existing plants thereby significantly reducing the time required for filling out the topiary frame as required of conventional topiary frames used for plants in their early stages of growth. The frame of the embodiment of the present invention is maneuverable, having extremities or extensions hinged about the frame to allow for opening and closing; and is thereby adapted to meet the needs of manipulating grown branches of mature plants or growing plants very easily within the frame to fill in extremities or extensions of the frame designs. In addition, a method of manufacturing of maneuverable topiary frames is described comprising forming rigid support pieces, separated into members; smoothly weaving a mesh framework around the support pieces; forming hinged connections to connect separated members; and permanently attaching clip mechanisms to release and secure members.

### BACKGROUND OF THE INVENTION

1. Field of Invention

This invention relates generally to topiary gardening and specifically to inserting and growing plants within improved wire frames for supporting plants in a variety of designs.

2. Background

The art of topiary involves the training, cutting, and trimming of plants, trees or shrubs into ornamental shapes. Three-dimensional frames are often used as templates to facilitate the growth of plants into desired forms. Two common types of topiary that utilize a frame are shrub and sphagnum topiary. Using shrub topiary techniques, frames are placed over growing plants that subsequently fill and cover the frame. Sphagnum topiary involves filling the frame with material, usually sphagnum moss, and then inserting seeds or plants into the moss.

Topiary frames have in the past been fabricated by means of using hand pressure over a mold and cutting wires to conform with desired structural forms. The number of cut open wires during this process is accompanied by a high risk of injury to workers or owners of the frames. Furthermore, the hand-made nature of the frames requires that workers have the requisite skill to make such frames, which limits the number of frames that can be manufactured per day, thereby resulting in problems of scale. Even among skilled workers, the product quality and design may not be entirely consistent due to varying degrees of experience.

Depending on the size of the frame, it can take months to years for plants to grow in and around the frame. Prior ornamental topiary frames have comprised a unitary structure with a hole at the bottom for insertion of the plant. This has often led to the limitation that only plants in their early growth stages could be inserted because the topiary frame could either not be placed on large or irregularly shaped plants or could not be placed without causing harm to the plant. Consequently, it took a long period of time before the plant assumed the shape of the topiary frame since the frame could accommodate only small, young plants that had to later mature and assume the shape of the topiary form.

For those not wanting to wait for shrub topiary to mature, sphagnum topiary provides a quicker method for creating shaped plants. Instead of waiting for a growing plant to assume the frame's shape, the frame is filled and covered with moss and then plants or seeds are placed in the moss. The advantage to this technique is that the gardener does not have to wait for the growing plant to assume the shape of the frame. However, for more complicated shapes, such as animals, it may be difficult and time consuming to properly compact the moss into the appendages of the frame through only a small aperture in the bottom of the frame.

Some have built topiary frames which comprise two halves to facilitate shipping of the frames. Topiary frames with separable halves also facilitate the filling of the frame with moss. Fasteners of various means, such as screws or cable ties are attached separately and hold the halves of these frames together. Each separable half is placed around the plant, joined with the other half, and then held together by fasteners. However, with frames of this separable nature, a risk is that the fasteners can easily be lost or misplaced due to their small size. Such frames also require the gardener to purchase a stock of fasteners. Furthermore, upon trying to insert larger plants into the frame, having to hold both halves of the frame together while trying to invoke the fastening means may present difficulties or inconveniences. In addition, such frames are not adjustable once fastened together.

Therefore, what is needed is a topiary frame possessing separable and maneuverable sections as well as permanently attached fasteners to provide for the placement of more mature plants or simplifying the placement of moss into a topiary frame.

### SUMMARY OF THE INVENTION

It is an object of the invention to produce a topiary frame that comprises maneuverable sections with no obstacles of assembly and attachment before use. The maneuverable section allow the frame to be used with more mature plants; by easily wrapping around grown plants and allowing plant branches and foliage to be positioned throughout the frame sections.

It is a further object of the invention to provide additional openings on the body of the topiary frame to facilitate insertion of plants and filler in hard to reach areas of the frame.

Another object of the invention is to produce a topiary frame that allows a standardized method of manufacture on a large scale without risks of injury to workers by reducing the amount of sharp edges on topiary frames.

Another object of the invention is to produce a topiary frame utilizing a woven mesh framework method instead of pressing a mesh framework around a topiary frame that requires cutting the excess wire.

These and additional objects are achieved by a topiary frame and method of fabricating the same wherein the topiary frame comprises maneuverable sections that are opened by a hinge attaching separate sections. When a clasp is released, the separate sections open and close about a hinge. For frames possessing extremities, such as an animal shape, the torso of the frame also contains hinges corresponding to and connecting each extremity to the torso. The hinging members of the extremities operate by release of corresponding clasps, which allow each extremity to swing open to allow plants and filler to be inserted.

The method of making the maneuverable topiary frame comprises a standardized process of forming a support frame based on a computer-generated layout of a particular design; the support frame made of rigid support pieces and separable into members. The method further comprises weaving a mesh framework of wire about the support pieces to fill in the large spaces between the support pieces; weaving a hinged connection between two or more members to allow for pivoting or movement of the members; further integrating one or more permanent clips or other locking mechanisms on the members near the opposite side of the hinged connection to allow for closing and opening the members. The locking mechanisms when all engaged keep the entire frame in a sturdy position; when disengaged, the members are made free to move, pivot, swing, open to facilitate manipulating foliage inside the frame. The maneuverability of the frame members assists the gardener to reach smaller areas of the frame, to guide plants/foliage into areas of the frame not possible before. The standardized process gives the frames a uniform appearance and lowers production time. The process further minimizes the safety hazards of conventional methods which use cut wires to give the frame shape, leaving dangerous sharp edges for anyone handling the frame.

In other embodiments of the method of manufacture, the frame is further coated with weatherproof or rustproof substances. The frame may also be manufactured with an existing plant inside the frame.

These and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 illustrates a front view of the apparatus in a closed position according to an embodiment of the present invention.

FIG. 2 illustrates a font view of the apparatus in an open position according to an embodiment of the present invention.

FIG. 3 illustrates a bottom view of the apparatus in a closed position according to an embodiment of the present invention.

FIG. 4 illustrates a front view of the apparatus filled with plant material and in use according to an embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Though the illustrations and descriptions disclose a symmetrical topiary structure, this does not preclude an asymmetrical topiary structure from falling within the scope of the invention. Section titles are terse and are for convenience only.

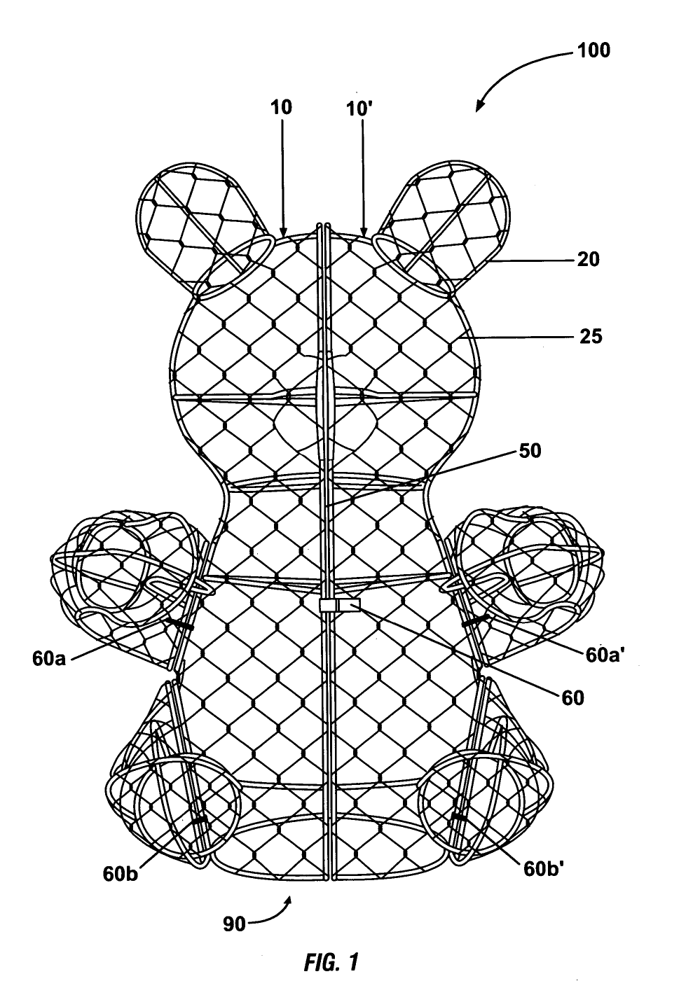

According to FIG. 1, an embodiment of the maneuverable topiary frame is shown in a three-dimensional unitary form 100. In the illustrative embodiment in FIG. 1, the topiary structure is that of a bear. Of course, the topiary structure could take the shape of myriad other animal, geometric, letter, and artistic shapes with the bear shape of FIG. 1 used solely as an illustrative embodiment.

The topiary structure in FIG. 1 is constructed from several separable members 10 to form a three dimensional unitary form 100. In this embodiment of the topiary frame, separable member 10 has a corresponding separable member 10′. The separable members 10 comprise support pieces 20 that provide a base for the shape of the topiary frame with a mesh framework 25 connected to the support pieces 20 to give the separable members 10 a three-dimensional shape. The mesh framework 25 serves as a frame filler between the spaces between the support pieces 20. The combination of these separable members 10 forms the overall three-dimensional unitary form 100.

The support pieces 20 can be created from any material capable of maintaining a predetermined shape. In the present embodiment, the support pieces are created from rigid high gauge wire, such as galvanized steel. The wire support pieces are smoothly soldered together. Although, it is further understood that the members could be formed from other materials such as metal rods, plastic, or wood.

A mesh framework 25 is placed over the support pieces 20 to further define the predetermined three-dimensional shape of the separable members 10. Any number of materials can be used to create the mesh framework 25. In the present embodiment a thin hexagonal wire mesh, sometimes called chicken wire, is woven about the support pieces 20. However, other materials such as string or plastic could also be used to create a mesh framework 25. Further, the mesh framework 25 is not limited to a hexagonal arrangement but may be shaped like other net-like designs. The mesh framework 25 may have any arrangement so long as it helps to provide shape for the separable members 10. The spaces within the mesh framework 25 do not have to be uniformly the same size and can vary depending on the location of the mesh on the topiary structure. Certain members can be covered with a mesh framework of closer spaces than upon other members so to better shape areas of the topiary which need a more distinctly defined area.

FIG. 1 illustrates an embodiment of the topiary frame as a bear shape. The three-dimensional unitary form 100 is formed from two or more separable members 10, 10′ that make up the overall shape of the structure. Separable members 10, 10′ are connected to one another at hinged connections 50 upon which the members may pivot. Clips or clasps 60 are permanently attached to the frame which when engaged secure the members closed or when disengaged allow members to open when necessary. At least one clip 60 is integrally affixed to at least two adjoining separable members 10. The clip 60 releases a separable member 10 to pivot or rotate along an axis (where the hinged connection 50 is located) thereby enabling the opening and closing of a separable member 10 in relation to an adjacent separable member 10′. Separable members 10, 10′ are restricted in their movement through the use of a clasp 60. When engaged, the clip 60 prevents the separable members 10, 10′ from moving about their hinge 50. The present embodiment of a bear shape has six separable members 10 interconnected with five or six clips 60 and a number of hinges 50. For instance, the main body pivots open as members 10, 10′; other moving members correspond to each of the arms and each of the legs. Clips 60a, 60a′ correspond to the arms while clips 60b, 60b′ correspond to the legs respectively.

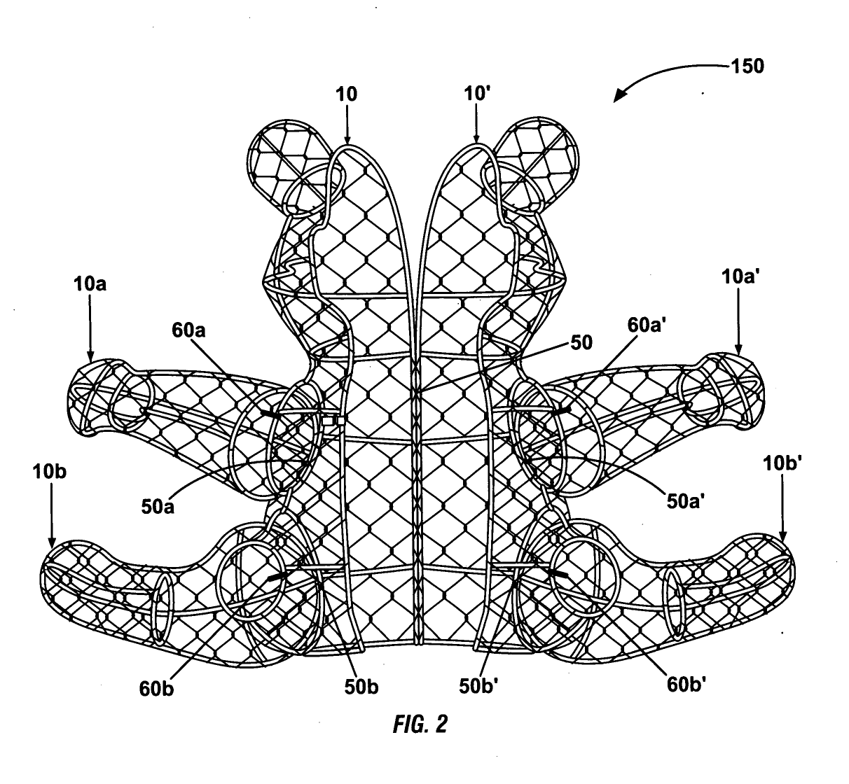

According to another embodiment of the invention as shown in FIG. 2, the three-dimensional unitary form in an open position 150 has all of the separable members open. The ability to maneuver the separable members 10, 10′ facilitates the placement of the topiary structure about a plant. The separable members for the legs 10a, 10a′ and the separable members for the legs 10b, 10b′ move independently from every other separable member. Disengaging the clips or clasps 60 and allowing the separable members to pivot or rotate about the hinges 50 that connect one separable member to another, opens the separable members of the topiary. For instance, in the embodiment, hinge 50 connects members 10, 10′, hinge 50a connects member 10a to member 10; hinge 50a′ connects member 10a′ to 10′; hinge 50b connects member 10b to member 10; and hinge 50b′ connects member 10b′ to member 10′. The empty topiary structure is then placed about a plant where the open separable members 10 facilitate the placement of the plant within the various separable members 10. Once the plant is in place, the separable members 10 are then closed and the clasps 60 are engaged to form a three-dimensional unitary form 100 containing a plant. Since the clips 60 are a permanent and integral part of the frame, requiring no assembly, the frame can be instantly used with existing grown plants. There is no required assembly to use the frame and because the members are connected by hinges 50, the frame can be manipulated very easily as many times as necessary without requiring the connections to be broken and reattached.

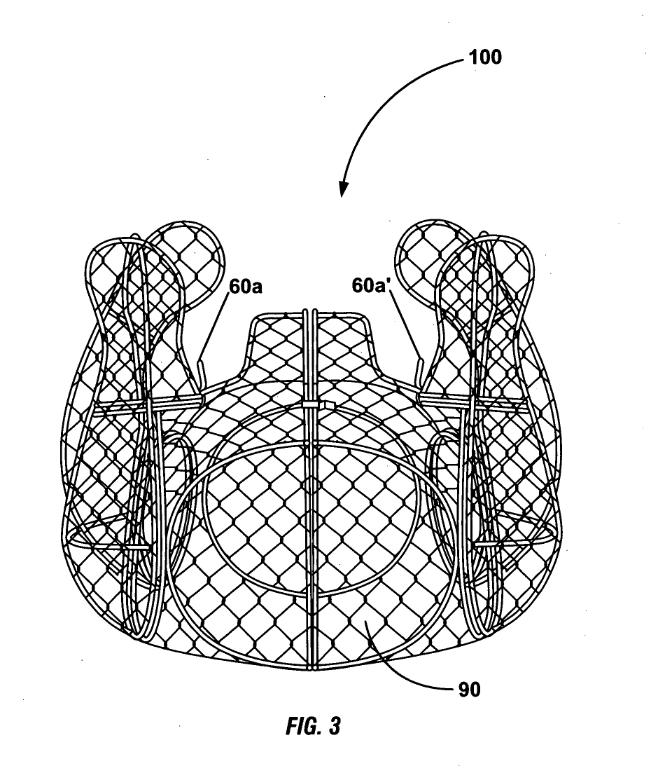

According to the embodiment of the invention as illustrated in FIG. 3, a three-dimensional unitary form 100 is shown from a bottom view, having an aperture 90 that facilitates the placement of the topiary structure about a plant. The aperture 90 allows for the plant to grow up into the topiary as well. In addition to placement of a growing plant inside the topiary, the aperture 90 can facilitate filling of the topiary structure with a filling material such as sphagnum moss. However, since the separable members 10 are capable of opening, an aperture 90 is not required for filling the topiary with a filler material.

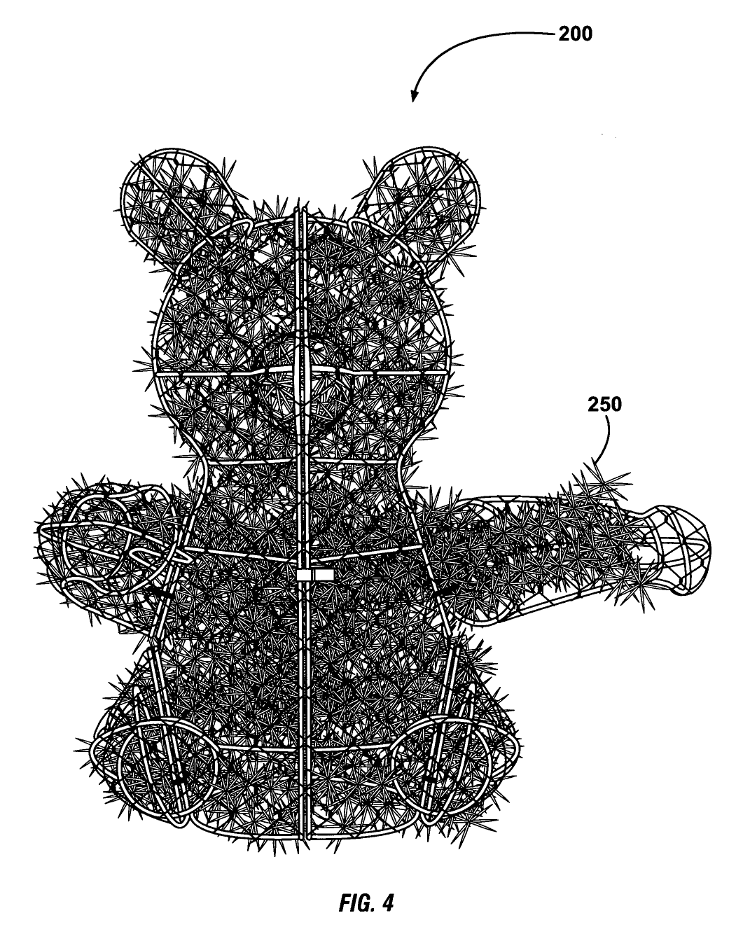

According to the embodiment of the invention shown in FIG. 4, the topiary structure in use 200 has been placed about a plant 250. While there is no limitation on the type of plant, Boxwood, Juniper, False Heather, and Juniper Toulosa are examples of plants that are often used to grow over and assume the shape of a topiary frame. When the topiary frame is placed over a growing plant, in one embodiment, the plant can grow up through the aperture 90 located at the bottom of the topiary structure. To facilitate the placement of larger or more mature plants within the topiary structure, specific separable members 10 are capable of having their clasps 60 disengaged allowing the separable member to open and enabling placement of part of a plant within the separable member. Once the plant is located within the topiary, the clasps 60 are engaged to close the separable members 10 which surround the plant.

An embodiment of the invention provides the method of manufacture of the topiary structure. The method involves the forming of separable members 10 using support pieces 20 based on a computer-generated template or layout of the ornamental or animal form. Such use of the layout allows for streamlining of the production process and facilitates uniformity of the appearance of the final formed topiary frame. High gauge wire is used to create the support pieces 20 and a minimal amount of solder is used to attach the support pieces 20 together. Of course, it is understood that if other materials are used to create support pieces 20, a suitable means of attachment will be used to connect them.

Additionally, one or more wires are woven about the support pieces 20 to form a mesh framework 25, again using a minimal amount of solder, to bridge the spaces between support pieces 20 and further provide an overall shape to the separable members 10 which, when combined, form the three-dimensional unitary form 100. The process of smoothly weaving wires to create the mesh framework 25 has the advantage of minimizing the number of sharp edges or protruding wire ends which could injure a person or plant. The wires are woven about separable members 10 to also form the hinged connections which enable the members to pivot or rotate open and closed. In addition, a clip or clasp is permanently affixed to the members 10 at points near the opposite of the hinged connections. These clips or locking mechanisms are integral parts of the frame and may comprise for example, clasps, adjustable ties, latches, hooks, bent wires or locks. When the clips are engaged, the members 10 are secured closed and when the clips are disengaged, the members 10 are released to move about the hinged connections. Releasing the clips and maneuvering the members 10 allows the user to easily manipulate foliage throughout the reduces the amount of time necessary to wait for younger plants to fill in the frame and thereby allows the frame to be used with mature plants for creating instant topiaries.

Furthermore, the method for manufacturing the maneuverable topiary frame may additionally comprise weatherproofing or rustproofing the wire material used for the frame. Galvanized steel is typically used, although a coating step may also be incorporated at the end of the process to coat the frame with a rustproof substance. Other materials may be used besides wire material to create the maneuverable topiary frame as long as the material is sturdy enough to maintain the shape of the topiary design.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description, but rather is indicated by the appended claims. All changes that come within the meaning and range of equivalents within the claims are intended to be considered as being embraced within the spirit and scope of the claims.

1. A maneuverable topiary frame comprising:
a) two or more separable members,
b) one or more hinges, integrally a part of the frame, and connecting at least two adjoining separable members,
c) one or more clips permanently affixed to a member; wherein at least one of the hinges adjoining two of the members forms a main structure having an interior side and an exterior side, and wherein the one or more clips when released enable one or more of the two or more separable members to move upon a center axis and pivot or rotate along their one or more hinges such that the interior side of the main structure is completely exposed allowing for the main structure to enclose around a growing plant, and when engaged secure the two or more separable members from moving, as a three-dimensional unitary form.

2. The maneuverable topiary frame of claim 1, wherein the two or more separable members further comprise
support pieces to support the entire fame; and
frame filler along a number of gaps between the support pieces to provide further shape and stability to the frame.

3. The maneuverable topiary frame of claim 2, wherein the frame filler comprises a mesh framework woven over and about the support pieces.

4. The maneuverable topiary frame of claim 1, wherein said one or more hinges are provided by two lengths of wire interwoven along a common axis of two separate members.

5. The maneuverable topiary frame of claim 1, wherein said one or more clips are selected from the group consisting of bent wires, hooks, clasps, latches, ties and locks.

6. The maneuverable topiary frame of claim 3, wherein the support pieces are constructed of a higher gauge wire than the filler constructed of a lower gauge wire.

7. The maneuverable topiary frame according to claim 1, wherein
the three-dimensional unitary form comprises an animal form, having an upper and lower extremity set of members corresponding to arms or legs of a particular animal design for enclosing topiary foliage;
the main structure corresponding to a torso region of the animal design; and each of the extremity members connecting to the torso region.

8. The maneuverable topiary frame according to claim 7, wherein
the upper and lower extremity set of members correspond to objects in addition to arms or legs;
the main structure corresponding to a middle region of the animal form; and each of the extremity members connecting to the middle region.

9. The maneuverable topiary frame according to claim 7, wherein the animal form is a bear design.

10. The maneuverable topiary fine according to claim 8, wherein the animal form is a seal design and the object is a ball shape.

11. The maneuverable topiary frame according to claim 1, wherein one or more clips are located opposite the hinge adjoining two members that forms the main structure.

12. The maneuverable topiary frame of claim 1 wherein the support pieces are comprised of galvanized metal wires.

13. A method for making a maneuverable topiary frame comprising the steps of:
a) fashioning support pieces from one or more wires into a desired frame shape using minimal amount of soldering, the frame shape separated into at least two parts;
b) weaving one or more long wires of thinner gauge that the wire of the support pieces, hereinafter thin wire, to produce a wire mesh filler to fill in a plurality of spaces between the wire of the support pieces, wherein little or no soldering is used to secure the thin wire to the support pieces, thereby minimizing potential safety hazards from sharp edges;
c) weaving one or more thin wires to connect at least two of the separated parts of the frame shape, thereby forming one or more hinged connections of the separated parts, the hinged connections allowing for movement of the separated parts;
d) attaching permanently one or more clips to the support pieces, opposite the hinged connection of the separated parts;
wherein the support pieces are formed to leave an opening at a bottom of the frame to allow for insertion of a foliage; and
wherein the clips when engaged secure the separated parts closed, and when released enable the separated parts to move open along the hinged connection, thereby facilitating insertion and manipulation of the foliage.

14. The method for making a maneuverable topiary frame according to claim 13, wherein the desired shape of the support pieces is an animal design and the separable parts include lower and upper skeletal members of the animal design.

15. The method for making a maneuverable topiary frame according to claim 13, wherein the wires are comprised of galvanized metal.

16. The method for making a maneuverable topiary frame according to claim 13, further comprising the step of coating the wires with a rustproof substance.

17. The method for making a maneuverable topiary frame according to claim 13, wherein the wire mesh filler resembles hexagonal wire and is further hand woven, not press molded, thereby minimizing rough edges.

18. The method for making a maneuverable topiary frame according to claim 13, wherein the wire mesh filler is woven using a single long strand of wire.

19. The method for making a maneuverable topiary frame according to claim 14, wherein the wire mesh filler is woven more densely in some of the lower and upper skeletal members than in other separable parts.

20. A method for making a maneuverable topiary frame, comprising the steps of:
a) generating a computer layout of a desired topiary frame shape;
b) fashioning support pieces from one or more wires into the desired frame shape according to the layout, using minimal amount of soldering, the five shape separated into at least two parts;
c) weaving one or more long wires of thinner gauge that the wire of the support pieces, hereinafter thin wire, to produce a wire mesh filler to fill in a plurality of spaces between the wire of the support pieces, wherein little or no soldering is used to secure the thin wire to the support pieces, thereby minimizing potential safety hazards from sharp edges;
d) weaving one or more thin wires to connect at least two of the separated parts of the frame shape, therein forming one or more hinged connections of the separated parts; the hinged connections allowing for movement of the separated parts;
e) attaching permanently one or more clips to the support pieces, opposite the hinged connection of the separated parts;
f) coating the topiary frame with a weatherproof or rustproof substance;
wherein the clips when engaged secure the separated parts closed, and when released enable the separated parts to move open along the hinged connection to facilitate insertion and manipulation of a foliage.

21. The maneuverable topiary frame according to claim 1, wherein the center axis is located at a half way point of the main structure.

22. The maneuverable topiary frame according to claim 7, wherein the upper and lower extremity set of members are separable from the main structure and each of the set of members pivots about a hinge connecting each of the set of members to the main structure, each of the set of members further comprising a clip opposite to its hinge for releasing and securing each of the set of members to the main structure.

23. The maneuverable topiary frame according to claim 22, wherein
the upper and lower extremity set of members correspond to objects in addition to arms or legs;
the main structure corresponding to a middle region of the animal form; and each of the extremity members connecting to the middle region.

24. A maneuverable topiary frame comprising:
a) two or more separable members,
b) one or more hinges, integrally a part of the frame, and connecting at least two adjoining separable members,
c) one or more clips permanently affixed to a member;
wherein at least one of the hinges adjoining two of the separable members forms a main structure having an interior side and an exterior side, the two members of the main structure being substantially symmetrical, and wherein the one or more clips
when released enable the two symmetrical separable members of the main structure to move upon a center axis and pivot or rotate along their one or more hinges, such that the interior side of the main structure is completely exposed and the two symmetrical separable members of the main structure are sufficiently opened for positioning around a grown plant and ease in manipulation of the plant throughout all separable members, and
when engaged fastens the two separable members of the main structure together around the plant, and secure the two or more separable members from moving, as a three-dimensional unitary form.
